(19) United States
(12) Patent Application Publication
(10) Pub. No.: US 2002/0005018 A1
(43) Pub. Date: Jan. 17, 2002

(54) Invisible downspout

(76) Inventors: Viorel Popa, Bellevue, WA (US); Mioara Popa, Bellevue, WA (US)

Correspondence Address: Law Offices of, John D. Gugliotta P.E., Esq., 202 Delaware Building, 137 South Main Street, Akron, OH, 44308, US

(21) Appl. No.: 09/906,341

(22) Filed: Jul. 16, 2001

Related U.S. Application Data
(63) Continuation-in-part of application No. 09/418,402, filed on Oct. 14, 1999.

(51) Int. Cl. B05D 7/00; E04D 13/08

(52) U.S. Cl. 52/16; 427/212

(57) ABSTRACT

This invention is a downspout used to carry water over a roof's surface from one roof plane to another gutter or downspout. The down spout is a rectangular piece of aluminum with granulated surface to match the color and contour of the roof. This invention will eliminate water stains associated with water coming down from the gutter.

### RELATED APPLICATIONS

The present invention is a Continuation in Part of U.S. application Ser. No. 09/418,402 filed on Oct. 14, 1999.

### BACKGROUND OF THE INVENTION

1. Field of the Invention

The present invention relates generally to roofing gutters and downspouts and, more particularly, to conventional downspout and gutter pieces coated with a material that matches the aesthetic background of the roofing material thereby eliminating the unsightliness of the gutters and downspouts along the roofline.

2. Description of the Related Art

The concept embodied in the present invention is completely absent in the prior art. There exists prior art describing many different systems for gutters and downspouts and the application thereof on a structure. However, none of them are relevant here.

It is a known fact that gutters and downspouts form a necessary part of the protection of the house or building from the elements of the weather. While the gutters themselves can often be incorporated into the roof line design of a structure and straight vertical downspouts can often be hidden at the corners, down spouts that traverse a roof surface can be unsightly. Their often contrasting color and the angle at which they run across the roof, make them stand out even more. No matter how carefully they are planned and/or executed, they often look like an afterthought. One solution to this problem is the elimination of the interconnecting piece. This choice allows the water from the upper spout to exit and run across the roof in an uncontrolled manner where it is recaptured by the gutter on the lower roof. However, this solution, with its constantly falling water, has associated drawbacks. First, the constant running of water in the same location will discolor the roof surface with time, causing an even more unsightly view. Secondly, the running water will erode the surface of the roof near the exit of the upper down spout causing a premature failure of the roof. Accordingly, there is a need by which down spouts located on roofing surfaces can be made less visually intrusive. The development of the Invisible Downspout fulfills this need.

A search of the prior art did not disclose any patents that read directly on the claims of the instant invention; however, the following references were considered related:

| U.S. Pat. No. | Inventor | Issue Date |
|---|---|---|
| 4,028,895 | Franzmeier | June 14, 1977 |
| 3,967,452 | Maloney, Jr. et al. | November 30, 1976 |
| 5,794,384 | Dean et al. | August 18, 1998 |
| 5,678,359 | Turner | October 21, 1997 |
| 5,388,377 | Faulkner | February 14, 1995 |
| 4,980,997 | Tawzer | January 1, 1991 |
| 4,368,601 | Price | January 18, 1983 |
| ,994,055 | Maloney, Jr. et al. | July 6, 1976 |

### SUMMARY OF THE INVENTION

It is therefore an object of the present invention to provide conventional gutters and downspouts with a coating to match the roofing material.

It is a feature of the present invention to eliminate staining of roof material where a gutter or downspout may normally be kept off of the roof line because of unsightliness.

It is another feature of the present invention to eliminate excessive wear and tear on the roof due to constant water erosion.

It is yet another feature of the present invention to match the finish of the roof.

It is yet still another feature of the present invention to provide a better appearance at minimal cost.

Briefly described according to one embodiment of the present invention, downspouts and gutters that carry water from one gutter system to another across a roof can have their visual impact reduced by covering or coating them with a material similar in appearance to that of the roof surface. The invention would be made from a similar material as the rest of the down spout and gutter system. It is envisioned that aluminum or PVC would be the most common material. Next, an adhesive would be applied, followed by a coating of aggregate similar in color, size, shape, and texture to that of the roof surface.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the intended use of the Invisible Downspout on a roofline according to the preferred embodiment of the invention;

FIG. 2 is perspective view of a downspout section coated with aggregate material, according to the preferred embodiment of the present invention;

FIG. 3 is a perspective view of a downspout elbow section coated with aggregate material, according to the preferred embodiment of the present invention;

FIG. 4 is a perspective view of a downspout strap coated with aggregate material, according to the preferred embodiment of the present invention;

FIG. 5 is a perspective view of a gutter tee section coated with aggregate material, according to the preferred embodiment of the present invention; and

FIG. 6 is a perspective view of a gutter section coated with aggregate material, according to the preferred embodiment of the present invention.

### DESCRIPTION OF THE PREFERRED EMBODIMENTS

The best mode for carrying out the invention is presented in terms of its preferred embodiment, herein depicted within the following Figures.

1. Detailed Description of the Figures

Referring to FIG. 1 an Invisible Downspout 10 is shown in its intended usage along the roofline of a house. A coating of aggregate granular material is added to all exposed surface areas to blend the downspout into the roofline. The aggregate coating is affixed to the outer surface of the douwnspout or gutter by adhering to a mastic applied at the factory prior to attachment of the aggregate coating. The aggregate coating is envisioned as being available in a variety of colors and textures to match conventional off-the-shelf roofing materials. Any suitable downspout material can be selected for coating with the aggregate material with the most popular being aluminum or plastic. As is typical with downspout sections, it is envisioned that the Invisible Downspout would be available in convenient lengths such as eight, ten, and twelve feet and be able to be cut right at the job site to the desired length.

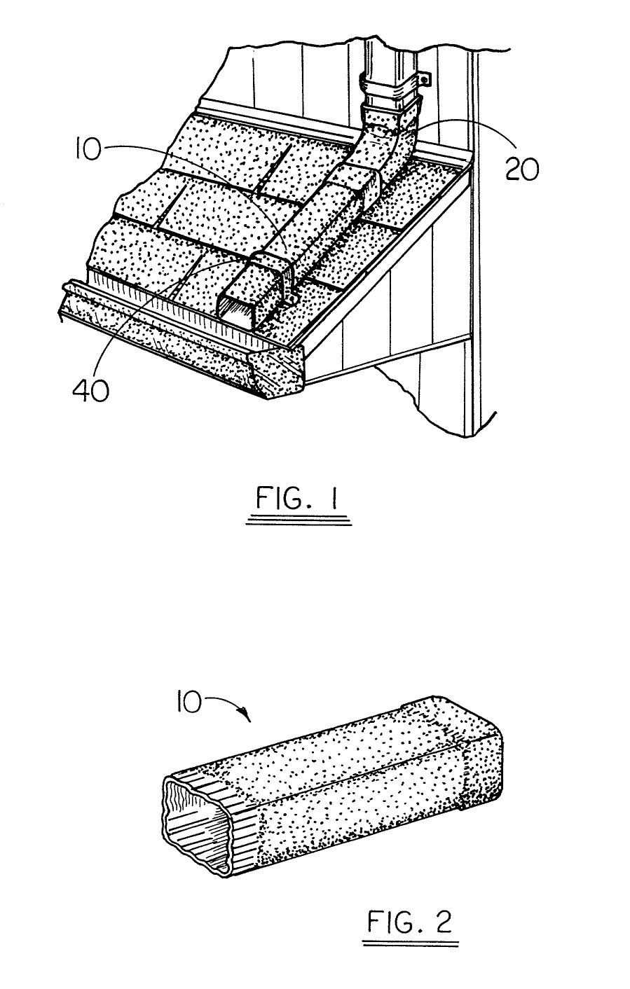

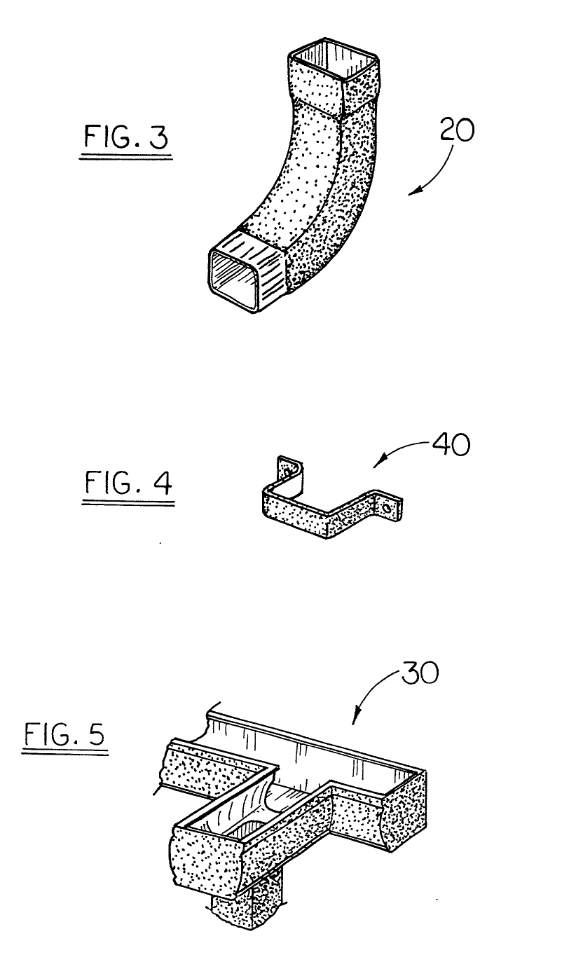

Referring now to FIGS. 2 through 4, shown are other necessary fittings cut and formed into pieces to interconnect and fit the Invisible Downspout 10 together. Such pieces include sections 10, elbows 20, couplings, and straps 40 coated with matching aggregate material. These fittings are typical in the installation of a downspout system but this list is not meant to be all inclusive.

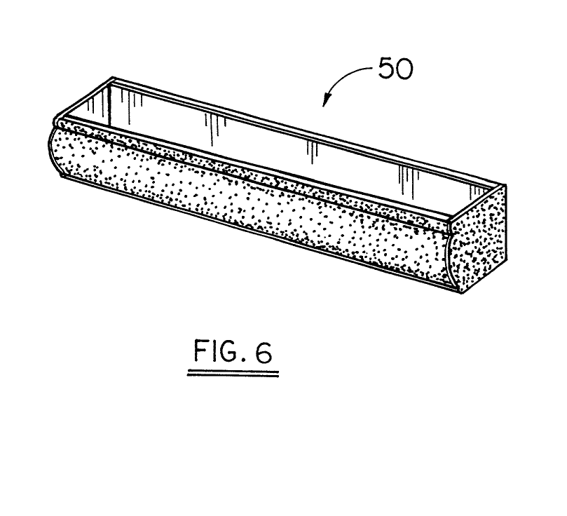

Referring now to FIGS. 5 and 6, shown are conventional gutter pieces that may be coated with matching aggregate material where it may be desired to also match the gutter with the roofline. The gutter may also be made from any suitable material such as aluminum or plastic cut and formed into pieces to interconnect the gutter together. Typical pieces such as a tee 30 and gutter section may pre-coated at the factory for immediate installation at the job site. Again, these fittings are typical in the installation of a gutter system but this list is not meant to be all inclusive.

The foregoing description is included to illustrate the operation of the preferred embodiment and is not meant to limit the scope of the invention. The scope of the invention is to be limited only by the following claims.

What is claimed is:

1. A system of downspout and gutters comprising:
a horizontal gutter conduit for the lateral communication of fluids collected from the roof of a home, said gutter conduit having a first sidewall forming an open receiving trough, said sidewall having a first outer surface;
a downspout conduit in fluid communication with said gutter conduit for vertical fluid transmission of fluids, said downspout conduit having a second sidewall circumscribing an inner annular space, said second sidewall having a second outer surface;
a mastic adhesive affixed to said first outer surface and said second outer surface; and
aggregate material adhered to said mastic adhesive, said aggregate material being of the color and texture of otherwise conventional roofing materials such that said first outer surface and said second outer surface match the roofing material of a home.

2. The system of downspouts and gutters of claim 1, wherein said system further comprises the use of a plurality of said downspout conduits

3. The system of downspouts and gutters of claim 1, wherein said system further comprises the use of a plurality of said gutter conduits

4. The system of downspout and gutters of claim 1, wherein said downspout is made of material selected from the group consisting of aluminum and plastic.

5. The system of downspout and gutters of claim 2, further comprising a pluraltiy of pieces to interconnect said downspouts, said gutters, or said downspout and said gutter together, said pieces selected from the group comprised of elbows, couplings, straps, and sections.
